(19) United States
(12) Patent Application Publication
(10) Pub. No.: US 2026/0302990 A1
(43) Pub. Date: Oct. 1, 2026

(54) Method for Controlling an Electric Drive Machine of a Motor Vehicle, Control Device for a Drive Machine, and Motor Vehicle

(71) Applicant: Bayerische Motoren Werke Aktiengesellschaft, Muenchen (DE)

(72) Inventors: Andreas KALLMEIER, Altenstadt/WN (DE); Klemens SCHUERHOLZ, Eching (DE)

(21) Appl. No.: 19/479,784

(22) PCT Filed: Jun. 6, 2024
(86) PCT No.: PCT/EP2024/065515

§ 371 Date: Oct. 29, 2025

(30) Foreign Application Priority Data
Jul. 7, 2023 (DE) 10 2023 118 074.6

(51) Int. Cl. H02P 23/20; B60L 15/20; F16H 1/26

(52) U.S. Cl. CPC H02P 23/20; B60L 15/20; F16H 1/26; B60L 2240/421; B60L 2240/423

(57) ABSTRACT

A method for controlling an electric drive machine of a motor vehicle, the drive machine having a rotor shaft which is connected to an output shaft of the motor vehicle via a gear train, wherein, during a load change of the drive machine, a torque provided by the drive machine is adjusted by accelerating the drive machine and decelerating the drive machine by a torque provided by the drive machine, in order to bridge play between teeth of intermeshing gears when switching between the drive flank and the coast flank.

### BACKGROUND AND SUMMARY

The invention relates to a method for controlling an electric drive machine of a motor vehicle, a control device for a drive machine, and a motor vehicle.

WO 2022/233535 A1 discloses a method for controlling an electric drive machine of a motor vehicle in order to reduce gearbox noise, the rotor shaft of the drive machine being connected to an output shaft of the motor vehicle by a gear transmission. In the event of a load change of the drive machine prior to a flank change of the gear transmission, a torque jolt of the drive machine is provided in order to adapt the common rotary motion of the gears of the gear transmission. This torque jolt is completed before the start of the flank change. The torque jolt is specified by a deviation function, and this deviation function, for a jolt duration between a jolt start and a jolt end, replaces or superposes the torque setpoint of an initial-torque profile of the drive machine provided for the load change.

An object of the present invention is to provide a solution that allows a particularly rapid changeover of a gear of a transmission between a drive flank and a coast flank with particularly low noise generation.

This object is achieved, according to the invention, by the subject-matter of the independent claims. Further possible embodiments of the invention are disclosed in the description and the figures. Features, advantages and possible embodiments set out in the description for one of the subject-matters disclosed herein are to be regarded, at least by analogy, as features, advantages, and possible embodiments of the respective subject-matter of other disclosed subject matter herein, and of any possible combination of the subject-matters, possibly in conjunction with one or more of the other subject-matters.

The invention relates to a method for controlling an electric drive machine of a motor vehicle. The electric drive machine is, in particular, part of an electric drive train of the motor vehicle and is configured to drive the motor vehicle by electrical energy. The electric drive machine may also be referred to as a traction machine. The motor vehicle is therefore a purely electrically drivable motor vehicle or a hybrid-electrically drivable motor vehicle. The electric drive machine comprises a rotor shaft which is connected to an output shaft of the motor vehicle via a gear transmission. With this gear transmission, the electric drive machine may be permanently coupled for torque transmission, or may be capable of being coupled to it and decoupled from it, for example by a clutch or the like. The gear transmission may comprise a first gear and a second gear which together form a gear-stage arrangement. In other words, the first gear and the second gear may mesh directly with one another, in which case the gear-stage arrangement then constitutes a single gear stage.

In the method it is provided that, during a load change of the drive machine, an acceleration of the drive machine and a deceleration of the drive machine are set by a torque provided by the drive machine, in order to bridge a backlash between the teeth of gears meshing with one another when changing over between the drive flank and the coast flank. In the context of the load change, a flank change of the gears meshing with one another therefore takes place. A flank change is to be understood to mean a transition of a contact between the gears from a flank of a tooth initially in mesh to the respectively opposite flank of the subsequently meshing tooth of one of the gears. This flank change is usually associated with a backlash, so that when there is a change in torque at one of the gears, an audible impact can occur when the new flank contact is established, which, if different torques are applied to the gears, depends on the respective relative speed with which the backlash is taken up. The term “common rotary motion” of two gears in engagement is to be understood, in particular, to mean the rotary motion which the two gears undergo in dependence on one another, i.e. in contact with one another, in particular when no flank change is taking place. The method does not therefore provide that merely a torque jolt in one direction is applied to the torque provided by the rotor shaft; instead, the torque provided by the rotor shaft is increased starting from an initial value and then lowered below this initial value. If a torque jolt were to be applied, the torque provided by the rotor shaft would only be either increased or decreased, depending on the direction of the torque jolt. With the method according to the invention, however, it is provided that the torque which is provided by the rotor shaft via the gear transmission for the output shaft is, in succession during the time span of the load change, positive and negative. In this case, the torque provided by the rotor shaft may be negative first and then positive, or positive first and then negative. The time span of the load change corresponds to the time required to bridge the backlash between the teeth during the changeover. The backlash may also be referred to as a gear-mesh backlash.

By way of example, it may be provided that, while the motor vehicle is being driven, the electric machine is back-driven, in particular because the motor vehicle is being driven by an internal combustion engine or by a further electric machine. As a result of back-driving the electric machine, the first gear assigned to the output shaft bears against a coast flank of the second gear assigned to the rotor shaft. Via this coast flank, the second gear is set into rotation. If the electric drive machine is now to be switched in and likewise used for driving the motor vehicle, a load change is to be carried out in which the first gear is brought into contact with the drive flank of the second gear. Accordingly, an angular setting between the first gear and the second gear is to be adjusted in order to bridge the backlash between the coast flank and the drive flank and, as a consequence, to change over from the coast flank to the drive flank. If the motor vehicle is no longer to be driven by the electric machine, then a further load change is to be performed in the gear transmission, in which a change back is made from the drive flank to the coast flank. The first gear is therefore to be adjusted from contact with the drive flank to contact with the coast flank of the second gear.

To enable adjustment between the drive flank and the coast flank within a particularly short time span, the torque provided by the electric machine is adapted. In this way, the backlash between the gears can be bridged particularly quickly by actively accelerating and decelerating the second gear.

In a possible development of the invention it is provided that if the teeth are changed over from the coast flank to the drive flank for the load change, the drive machine is first accelerated and then decelerated. This means that when, in the context of the load change, the first gear is to be brought from contact with the coast flank into contact with the drive flank, the second gear is first accelerated by providing positive torque and is subsequently decelerated through the provision of negative torque by the electric drive machine. As a result of this, the angular adjustment of the second gear relative to the first gear, which is necessary to bring the first gear from contact with the coast flank into contact with the drive flank, can be implemented particularly quickly. In addition, by decelerating the second gear as a result of providing the negative torque, the second gear is braked. This means that, starting from an initial rotational speed, the second gear is first accelerated during the load change and is subsequently braked back down to the initial rotational speed. Consequently, a relative speed of the teeth of the second gear with respect to the teeth of the first gear at the moment when the first gear is applied to the drive flank of the second gear is as low as possible, as a result of which noise generation as a consequence of the first gear striking the drive flank of the second gear can be kept particularly low.

In a further possible embodiment of the invention it is provided that if the teeth are changed over from the drive flank to the coast flank for the load change, the drive machine is first decelerated and then accelerated. This means that when, in the context of the load change, the first gear is to be brought from contact with the drive flank into contact with the coast flank, a negative torque is first provided by the electric drive machine and subsequently a positive torque. The negative torque provided by the electric drive machine causes a reduction in the rotational speed of the second gear starting from an initial rotational speed of the second gear. By slowing the second gear, the backlash during the changeover from the drive flank to the coast flank is bridged particularly quickly. During the load change, following the deceleration of the electric drive machine, the electric drive machine is then accelerated again, as a result of which a positive torque is applied to the second gear. Consequently, the reduced rotational speed of the second gear is raized again to the initial rotational speed, so that when the first gear is applied to the coast flank of the second gear, a relative movement between the teeth of the gears is as small as possible. In this way, any rattling due to the teeth of the first gear striking the coast flanks of the teeth of the second gear can be very effectively avoided. The method described therefore enables, on the one hand, particularly rapid bridging of the backlash between the gears and, moreover, a particularly gentle placement of the gears against one another after the backlash has been bridged.

In the cases described above, in which the load change of the teeth is made from the coast flank to the drive flank, or in which the load change of the teeth is made from the drive flank to the coast flank, the electric drive machine, in particular, has the same direction of rotation in both cases, the difference being that, in the first case, the electric drive machine is first accelerated and then decelerated during the load change, and in the second case, the electric drive machine is first decelerated and then accelerated during the load change.

In a further possible embodiment of the invention, it is provided that the torque provided by the drive machine follows a sinusoidal profile between a positive torque range and a negative torque range during the load change. This means that over the time span of the load change, the torque provided by the electric drive machine is varied in accordance with the profile of a sinusoidal curve. In this case, the torque over the time span of the load change follows the profile corresponding precisely to a sinusoidal wave with a negative amplitude and a positive amplitude. The wavelength of the sinusoidal profile of the torque in this case therefore corresponds to the time span required to carry out the load change and thereby bridge the backlash between the drive flank and the coast flank. A sine function is thereby superposed on the torque provided by the electric drive machine, wherein the initial torque provided by the electric drive machine before the load change and the torque provided by the electric drive machine immediately after completion of the load change are the same. During the load change, the torque of the electric drive machine is therefore raized starting from the initial torque in accordance with a sinusoidal profile and lowered below the initial torque, and towards the end of the load change set to the initial torque. Changing the torque provided by the electric drive machine during the load change in accordance with the sinusoidal curve enables the backlash between the gears to be bridged as quickly and comfortably as possible. Therefore, the method does not only involve a torque jolt being applied in one direction; instead, the sinusoidal profile is impressed on the torque, so that the torque provided by the drive machine is both increased and decreased.

In this context, it may in particular be provided that an amplitude height, a phase and a wavelength of the sinusoidal profile are selected as a function of a specified time span for the load change. In other words, the sinusoidal profile of the torque provided by the electric drive machine is selected in such a manner that the load change can be carried out within the specified time span. If, for example, it is specified that the load change is to take place within 10 milliseconds, and therefore the backlash between the gears is to be bridged within 10 milliseconds, then the sinusoidal profile of the torque provided by the electric drive machine is set in respect of amplitude height and wavelength in such a manner that this time specification for the load change can be met. The phase specification for the sinusoidal profile is particularly selected depending on whether the changeover is to be made from the drive flank to the coast flank or from the coast flank to the drive flank. In this case, the phase specification may, in particular, be selected as 0 or 0.5 times the wavelength, and therefore the time span. In particular, it is provided that, for the load change from the coast flank to the drive flank, a phase specification of 0 is selected for the sinusoidal profile, and for the changeover from the drive flank to the coast flank, a phase specification corresponding to half the wavelength is selected for the sinusoidal profile.

The method enables a particularly comfortable changeover of the gear flanks in the shortest possible time span. On the basis of the specified changeover time for the load change, the sinusoidal profile of the torque to be set for the electric drive machine follows. The method is therefore particularly designed to allow a time specification as to how quickly the flank change of the gears is to take place. In addition, a differential speed at which the respective flanks of the gears strike one another can be reduced.

By adapting the sinusoidal profile of the torque provided by the electric drive machine, it can therefore be achieved that the load change reliably takes place within the time specification and, moreover, that the load change can be implemented particularly quickly. Furthermore, the risk of the gears being applied to one another in noisy manner at the end of the load change can be kept particularly low.

In a further possible embodiment of the invention, it is provided that a speed of change of the torque provided by the drive machine is effected as a function of a maximum possible torque gradient of the drive machine. A maximum torque gradient of the electric drive machine is therefore utilized. In particular, the course of the sine function is set in accordance with the maximum possible torque gradient of the electric machine. The maximum torque gradient of the electric drive machine characterizes a steepest possible course of change of the torque, in particular the maximum possible fall or the maximum possible rise of the torque of the electric machine. The greater the maximum possible torque gradient of the electric machine, the faster or more strongly the electric drive machine can be accelerated or decelerated. The greater the maximum possible torque gradient of the electric drive machine, the higher the respective amplitude height of the sinusoidal profile can be, or the shorter the respective wavelength of the sinusoidal profile for the torque provided by the electric drive machine can be selected. This means that the higher the maximum possible torque gradient of the electric machine is, the shorter is the minimum time span required for the load change. The higher the maximum possible torque gradient of the electric drive machine, the faster the load change can be carried out. Due to the fact that the sinusoidal profile of the torque change of the electric drive machine is selected in such a manner that the maximum possible torque gradient of the drive machine is exploited, the full potential of the electric drive machine can be utilized with regard to the speed of the load change to be carried out.

The invention further relates to a control device for an electric drive machine of a motor vehicle. The control device is configured to control the electric drive machine in a method as already described in connection with the method according to the invention. In particular, by the control device, by controlling the electric drive machine, the torque provided by the electric drive machine can be set. The control device therefore enables a load change between a drive flank and a coast flank to be implemented in the gear transmission particularly quickly and, at the same time, with particularly low noise.

The invention further relates to a motor vehicle having an electric drive machine and having a control device, as already described in connection with the control device according to the invention. The control device is configured to control the electric drive machine of the motor vehicle in a method, as already described in connection with the method according to the invention. The motor vehicle is, in particular, an automobile, in particular a passenger car. In particular, the motor vehicle is embodied as a fully electrified motor vehicle or as a hybrid-electrified motor vehicle.

Further features of the invention may emerge from the claims, the figures and the description of the figures. The features and combinations of features mentioned above in the description, as well as the features and combinations of features shown individually below in the description of the figures and/or in the figures, can be used not only in the combination indicated in each case, but also in other combinations or individually, without departing from the scope of the invention.

### BRIEF DESCRIPTION OF THE DRAWINGS

FIG. 1 shows a schematic side view of a gear transmission, wherein a first gear bears against a coast flank of a second gear;

FIG. 2 shows a schematic side view of the gear transmission according to FIG. 1, wherein the first gear bears against a drive flank of the second gear;

FIG. 3 shows a partial schematic sectional view of the gear transmission with the first gear and the second gear;

FIG. 4 shows a graph depicting a change in a torque provided by an electric drive machine during a load change;

FIG. 5 shows a graph depicting a profile of the rotational speed of the second gear during the load change with respect to an initial rotational speed; and

FIG. 6 shows a graph depicting a profile of the angular offset of the second gear relative to the first gear during the load change.

### DETAILED DESCRIPTION OF THE DRAWINGS

In the figures, identical and functionally identical elements are provided with the same reference signs.

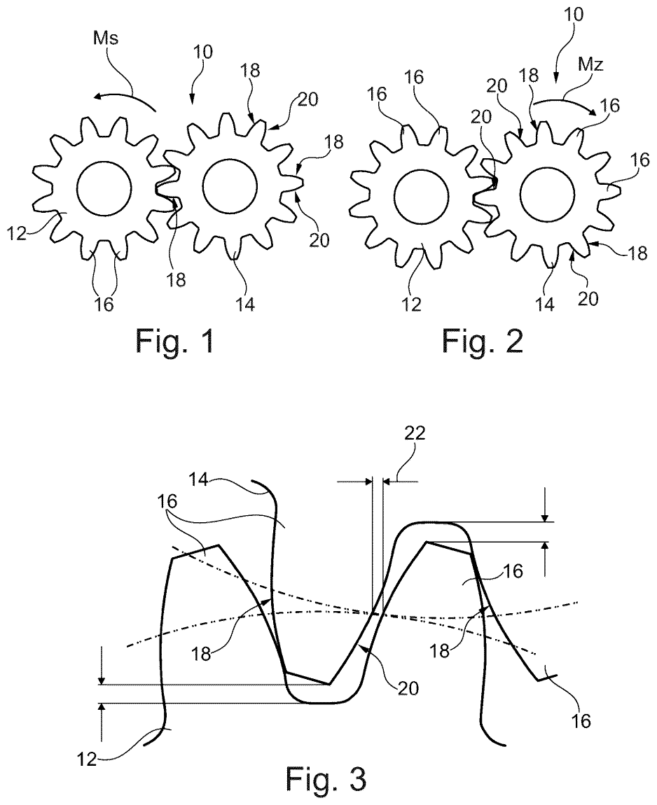

A gear transmission 10 of an electric drive train of a motor vehicle is shown in each of FIGS. 1 and 2. In addition to the gear transmission 10, the electric drive train comprises an electric drive machine configured to provide a torque for driving the motor vehicle. The drive train further comprises an output shaft which is connected in a torque-transmitting manner to wheels of the motor vehicle. This means that the torque provided by the electric drive machine is provided for the output shaft via the gear transmission 10. In this case, the gear transmission 10 is configured to convert the torque provided by the electric drive machine. The output shaft is connected in a torque-transmitting manner to a first gear 12. The electric drive machine is connected in a torque-transmitting manner to a second gear 14 of the gear transmission 10. In particular, the second gear 14 may be connected in a rotationally fixed manner to a rotor shaft of the electric drive machine. The first gear 12 and the second gear 14 mesh with one another. When the electric drive train of the motor vehicle is in coasting operation, a torque Ms is introduced via the first gear 12. The second gear 14 in this case is thereby pushed along by the first gear 12. In this coasting operation, driving of the motor vehicle by the electric drive machine does not take place. In the coasting operation, the motor vehicle may, for example, be driven by an internal combustion engine or by a further electric drive machine. In particular, in coasting operation the electric drive machine can be pushed along via the gear transmission 10. In coasting operation, the respective teeth 16 of the first gear 12 bear against respective coast flanks 18 of the second gear 14. Power transmission within the gear transmission 10 therefore takes place via the coast flanks 18 in coasting operation. For the sake of clarity, only some of the teeth 16 of the respective gears 12, 14 are provided with the associated reference signs.

In FIG. 2 the gear transmission 10 is shown in a drive operation of the electric drive train. In this drive operation, the motor vehicle is driven by the electric drive machine. This means that a torque Mz is introduced into the gear transmission 10 via the second gear 14. The direction of rotation of the respective gears 12, 14 is the same for the coasting operation shown in FIG. 1 and for the drive operation shown in FIG. 2. In the drive operation the teeth 16 of the first gear 12 bear against respective drive flanks 20 of the teeth 16 of the second gear 14. In drive operation, the torque Mz is introduced into the gear transmission 10 via the second gear 14, as a result of which the first gear 12 is driven by the second gear 14. In order to be able to switch from coasting operation to drive operation, or to be able to switch from drive operation to coasting operation, the teeth 16 of the first gear 12 are to be adjusted between contact with the respective coast flanks 18 and contact with the respective drive flanks 20.

As can be seen particularly clearly in FIG. 3, there is a backlash 22 between the gears 12, 14, which may also be referred to as gear-mesh backlash. In order to be able to switch between the coasting operation and the drive operation, this backlash 22 must be bridged. That means that for the changeover between the coasting operation and the drive operation, the second gear 14 is to be changed, relative to the first gear 12, in its angular position with respect to an axis of rotation of the second gear 14 and in a direction of rotation of the second gear 14, in order to bridge the backlash 22. In other words, the relative speed between the gears 12, 14 is to be changed, in order to enable the teeth 16 of the first gear 12 to be brought from contact with the respective coast flanks 18 into contact with the respective drive flanks 20, or from contact with the respective drive flanks 20 into contact with the respective coast flanks 18.

The gear transmission 10 is shown in part in FIG. 3 in the coasting operation of the electric drive train. In this case, the respective teeth 16 of the first gear 12 bear against the respective coast flanks 18 of the teeth 16 of the second gear 14. In order to release the teeth 16 of the first gear 12 from the respective coast flanks 18 of the respective teeth 16 of the second gear 14 and to bring them into contact with the respective drive flanks 20 of the teeth 16 of the second gear 14, the backlash 22 must be overcome by adapting the angular position of the second gear 14 with respect to the axis of rotation of the second gear 14 by changing the rotational speed. This bridging of the backlash 22 is also referred to herein as a load change. In the context of the load change, the backlash 22 between the teeth 16 of the gears 12, 14 meshing with one another is bridged when changing over between the drive flank 20 and the coast flank 18. This means that, at the load-change start 24 of the load change, the teeth 16 of the first gear 12 bear against the respective coast flanks 18 of the teeth 16 of the second gear 14 and, at the load-change end 26, bear against the respective drive flanks 20 of the teeth 16 of the second gear 14. Alternatively, at the load-change start 24 the teeth 16 of the first gear 12 bear against the drive flanks 20 of the teeth 16 of the second gear 14 and, at the load-change end 26, against the respective coast flanks 18 of the teeth 16 of the second gear 14.

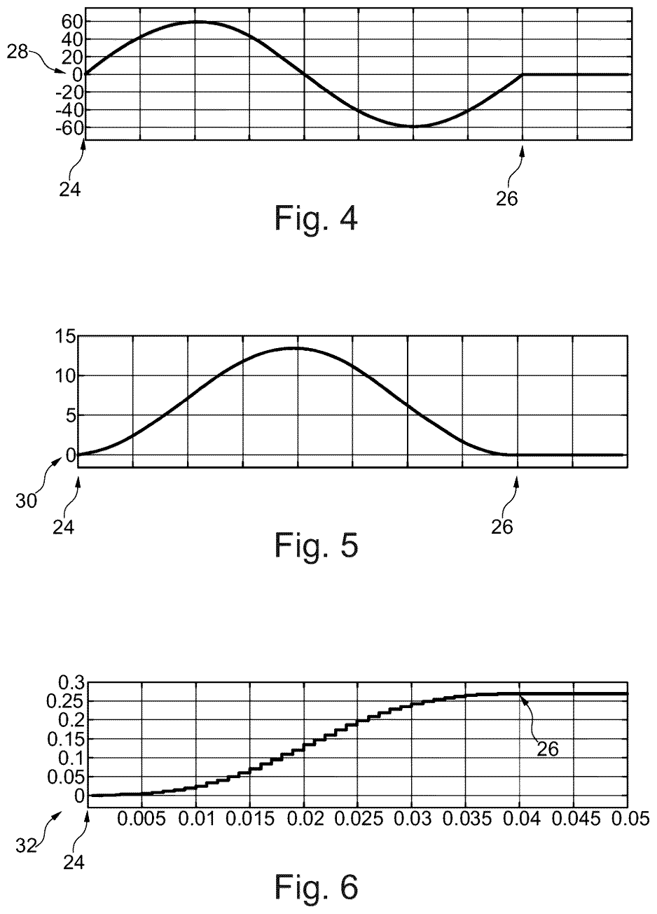

It is provided that, for the load change, the torque provided by the electric drive machine is modified. FIGS. 4, 5 and 6 respectively show graphs for an exemplary load change explained below. Within the framework of the load change visualized by the graphs shown in FIGS. 4 to 6, the electric drive train is, in particular, switched from the coasting operation to the drive operation. In the graphs, the respective parameters are shown from the load-change start 24 to the load-change end 26. In this case, the torque provided by the electric drive machine is shown in FIG. 4.

In other words, in FIG. 4 the initial torque 28 of the electric machine of 0 Nm is plotted on the ordinate. Time is plotted on the abscissa. In FIG. 5, for the same load change, time is likewise plotted on the abscissa and, on the ordinate, the rotational speed of the second gear 14 relative to an initial rotational speed 30. In other words, the value 0 along the ordinate denotes the initial rotational speed 30 of the second gear 14. In FIG. 6 an angle is plotted by which the second gear 14 is adjusted about its axis of rotation relative to an initial angular position 32, wherein the second gear 14 has the initial angular position 32 at the load-change start 24, as well as the time.

As can be seen in FIG. 4, during the load change, i.e. from the load-change start 24 to the load-change end 26, the torque provided by the electric drive machine follows a sinusoidal curve profile. That means, in the present case, that during the load change a positive torque is first provided by the electric drive machine and then a negative torque. The electric drive machine is therefore first accelerated and then decelerated for the load change. As can be seen in FIG. 5, starting from the initial rotational speed 30, the rotational speed of the second gear 14 rises over the course of the load change and finally falls back to the initial rotational speed 30. This means that, starting from its initial rotational speed 30, which corresponds to the value 0 on the ordinate, the second gear 14 is accelerated and is subsequently braked back down to its initial rotational speed 30.

In the present case, the change in rotational speed of the second gear 14 during the load change, starting from the initial rotational speed 30, follows at least substantially a cosine function with an offset. This enables the backlash 22 to be bridged particularly quickly by accelerating the second gear 14. After the acceleration, the second gear 14 is braked again, in order to avoid a clearly audible impact of the teeth 16 of the second gear 14 against the teeth 16 of the first gear 12.

In FIG. 6 the angular setting of the second gear 14 relative to an initial angular position 32 of the second gear 14 at the start of the load change is shown over time and therefore over the course of the load change. In this case, with the help of the slope of the curve, it can be seen in this case that, at the start of the load change, the angle of the second gear 14 is adjusted slowly, then more quickly by comparison, and subsequently the remaining angular adjustment of the second gear 14 takes place more slowly again.

The method described enables switching to take place between the coasting operation and the drive operation particularly quickly. In particular, a time span can be specified within which the load change is to be carried out. Depending on this specified time span, the sinusoidal profile of the torque provided by the electric drive machine can in turn be selected. In particular, an amplitude height, a phase, and a wavelength of the sinusoidal profile can be adjusted in this case in such a manner that the load change can be performed within the specified time span. To permit the shortest possible time span for the load change, the speed of change of the torque provided by the drive machine, and therefore the course of the sinusoidal curve, can be selected as a function of a maximum possible torque gradient of the drive machine. In other words, the course of the sinusoidal curve is selected in such a manner that the maximum possible torque gradient of the electric drive machine is exploited, in particular in that, during the load change, the maximum possible torque gradient of the electric drive machine is reached when changing the torque in accordance with the sinusoidal curve profile. The torque provided by the drive machine follows the sinusoidal profile between the positive torque range and the negative torque range during the load change.

If, instead of as in the example described, it is provided for the load change that the teeth 16 of the first gear 12 are brought from contact with the drive flank 20 into contact with the coast flank 18 of the teeth 16 of the second gear 14, then the electric drive machine is first decelerated and subsequently accelerated. In particular, during this load change the torque provided by the drive machine follows the sinusoidal profile, wherein the torque first lies in the negative torque range and then in the positive torque range. In other words, in this second alternative load change, the torque provided by the electric drive machine follows a sinusoidal profile of a curve which, compared with the curve shown in FIG. 5, is mirrored about the abscissa, i.e. multiplied by −1.

Within the framework of the method, a feed-forward control of a torque profile of the torque provided by the electric drive machine is performed, in order to be able to displace the second gear 14, which is connected in a rotationally fixed manner to the electric drive machine, by a defined angle. The method described makes it possible for the second gear 14 driven by the electric drive machine to be adjusted particularly quickly between the drive flank 20 and the coast flank 18. With a simple linear torque profile of the torque provided by the electric drive machine, a differential speed between the second gear 14 and the first gear 12, at the moment when the teeth 16 of the first gear 12 strike the coast flank 18 or the drive flank 20 of the second gear 14, would be non-zero. Furthermore, with the linear torque profile, a maximum available dynamic response of the electric drive machine would not be utilized for taking up the backlash 22. By specifying the behaviour of the electric drive machine not by way of the linear torque profile but by way of the sinusoidal torque profile, both an impact speed of the teeth 16 of the first gear 12 and of the second gear 14 at the load-change end 26 can be minimized and a dynamic response of the electric drive machine can be utilized particularly effectively.

Overall, the present disclosure shows how a flank-change function can be implemented, in which a precontrolled traversal of a backlash 22 of the gear transmission 10 takes place when there is a change of sign.
LIST OF REFERENCE SIGNS
10 gear transmission
12 first gear
14 second gear
16 tooth
18 coast flank
20 drive flank
22 backlash
24 load-change start
26 load-change end
28 initial torque
30 initial rotational speed
32 initial angular position

1-8. (canceled)

9. A method for controlling an electric drive machine of a motor vehicle, the drive machine comprising a rotor shaft that is connected to an output shaft of the motor vehicle via a gear transmission, the method comprising:
setting, during a load change of the drive machine, an acceleration of the drive machine and a deceleration of the drive machine by a torque provided by the drive machine, to bridge a backlash between teeth of gears meshing with one another when changing over between a drive flank and a coast flank.

10. The method according to claim 9, comprising:
first accelerating and then decelerating the drive machine when the teeth are changed over from the coast flank to the drive flank for the load change.

11. The method according to claim 9, comprising:
first decelerating and then accelerating the drive machine when the teeth are changed over from the drive flank to the coast flank for the load change.

12. The method according to claim 9, comprising:
providing the torque by the drive machine during the load change so that the torque follows a sinusoidal profile between a positive torque range and a negative torque range.

13. The method according to claim 12, comprising:
selecting an amplitude height, a phase, and a wavelength of the sinusoidal profile as a function of a specified time span for the load change.

14. The method according to claim 9, comprising:
effecting a speed of change of the torque provided by the drive machine as a function of a maximum possible torque gradient of the drive machine.

15. A control device for an electric drive machine of a motor vehicle, wherein the drive machine comprises a rotor shaft that is connected to an output shaft of the motor vehicle via a gear transmission, wherein the control device is configured to:
set, during a load change of the drive machine, an acceleration of the drive machine and a deceleration of the drive machine by a torque provided by the drive machine, to bridge a backlash between teeth of gears meshing with one another when changing over between a drive flank and a coast flank.

16. The control device according to claim 15, wherein the control device is configured to:
first accelerate and then decelerate the drive machine when the teeth are changed over from the coast flank to the drive flank for the load change.

17. The control device according to claim 15, wherein the control device is configured to:
first decelerate and then accelerate the drive machine when the teeth are changed over from the drive flank to the coast flank for the load change.

18. The control device according to claim 15, wherein the control device is configured to:
provide the torque by the drive machine during the load change so that the torque follows a sinusoidal profile between a positive torque range and a negative torque range.

19. The control device according to claim 18, wherein the control device is configured to:
selectin an amplitude height, a phase, and a wavelength of the sinusoidal profile as a function of a specified time span for the load change.

20. The control device according to claim 15, wherein the control device is configured to:
effect a speed of change of the torque provided by the drive machine as a function of a maximum possible torque gradient of the drive machine.

21. A motor vehicle comprising:
an electric drive machine; and
the control device according to claim 15.
